(19) United States
(12) Patent Application Publication
(10) Pub. No.: US 2022/0063743 A1
(43) Pub. Date: Mar. 3, 2022

(54) MOTORCYCLE KEYLESS CONTROLLER ARRANGEMENT STRUCTURE

(71) Applicant: KWANG YANG MOTOR CO., LTD., Kaohsiung City (TW)

(72) Inventor: HAO-YU WU, KAOHSIUNG CITY (TW)

(21) Appl. No.: 17/387,980

(22) Filed: Jul. 28, 2021

(30) Foreign Application Priority Data
Aug. 28, 2020 (TW) 109211288

(51) Int. Cl. B62H 5/06; B62H 5/08; B62H 5/20

(52) U.S. Cl. CPC B62H 5/06; B62H 5/20; B62H 5/08

(57) ABSTRACT

A motorcycle keyless controller arrangement structure is provided. A motorcycle includes a vehicle frame unit, a vehicle body cover unit, and a steering mechanism mounted on the vehicle frame unit. The steering mechanism includes a steering handle bar and a front fork assembly. a front cover portion of the vehicle body cover unit is arranged on a front side of the front fork assembly. A keyless controller is arranged on a rear side of the front fork assembly. The keyless controller is in electrical connection with a long-range antenna and a short-range antenna. The long-range antenna is arranged inside the front cover portion. The short-range antenna is arranged inside an upper vehicle-body cover portion of the vehicle body cover unit. As such, the motorcycle is kept in a condition of being ready to enter a traveling state.

### TECHNICAL FIELD OF THE INVENTION

The present invention relates to a motorcycle keyless controller arrangement structure, and more particularly to a motorcycle keyless controller arrangement structure that ensures a motorcycle can instantaneously enter a travelable state.

### DESCRIPTION OF THE PRIOR ART

In consideration of various factors, such as environmental preservation and energy saving, vehicles (two-wheeled vehicles) have gained prevailing by the public. To ease operation control of a vehicle by a rider, manufactures often install a keyless controller on a vehicle, so that it only needs for the rider to carry an electrical signal sensor (remote controller) and approach the vehicle, to allow the keyless controller detects and identifies if the electrical signal sensor is an electrical signal sensor matching therewith, and if yes, the keyless controller goes into operation, allowing various electrical components of the vehicle to enter a ready-to-use condition, so that the rider may start the vehicle without a key thereby enhancing the effectiveness of operating the vehicle by the rider.

As shown in FIG. 1, conventionally, a vehicle 1 is provided with a keyless controller 13 arranged between a seat cushion 11 and a steering mechanism 12. The keyless controller 13 is provided, in an interior thereof, with a sensing antenna (not shown in the drawings) and a mechanical rotation style control knob 131. When a rider who carries an electrical signal sensor 14 approaches the keyless controller 13 by a predetermined distance, the keyless controller 13 carries out sensing detection to identify whether matched or not. If yes, the keyless controller 13 causes the control knob 131 to release locking and meanwhile, causing other electrical components to be energized, so that the rider may rotate the control knob 131 to cause a steering mechanism lock (not shown in the drawings) that locks up the steering mechanism for rotation to release the locked state of the control knob 131, thereby allowing the steering mechanism 12 to be operated for making turning operations of the motorcycle 1, and also to start the motorcycle 1 to enter a travelable state by operating the control knob 131.

Although the known arrangement structure of the keyless controller 13 of the motorcycle 1 described above is effective in enabling a rider to start a vehicle without using a key and thus achieving the effectiveness of easing the rider's use and operation of the vehicle. However, in case that the electrical signal sensor 14 is in shortage of electrical power and is incapable of giving off signals, the keyless controller 13 may not detect and identify the electrical signal sensor 14, meaning the keyless controller 13 of the motorcycle 1 cannot be activated and this makes it is not possible for the motorcycle 1 to enter the travelable state. Further, the control knob 131 is generally bulky in size and would surely cause deterioration of the product outside appearance of the vehicle body between a front side of the seat cushion 11 and the steering mechanism 12 of the motorcycle 1.

Thus, it is a challenge of the motorcycle manufacturers to provide a motorcycle keyless controller arrangement structure that ensures the keyless controller can be activated to make the motorcycle entering a travelable state.

### SUMMARY OF THE INVENTION

The primary objective of the present invention is to provide a motorcycle keyless controller arrangement structure that mainly overcomes the drawback of a prior art electrical signal sensor of a motorcycle that does not enable activation of a keyless controller due to insufficiency of electrical power, so as not to cause the motorcycle to enter a travelable state.

For such a purpose, the first primary technical measure adopted in the present invention is to provide a motorcycle keyless controller arrangement structure, wherein a motorcycle comprises a vehicle frame unit, a vehicle body cover unit, and a steering mechanism mounted on the vehicle frame unit, the steering mechanism comprising a steering handle bar and a front fork assembly, a front cover portion of the vehicle body cover unit being arranged on a front side of the front fork assembly, a keyless controller being arranged on a rear side of the front fork assembly; the keyless controller is in electrical connection with a long-range antenna and a short-range antenna, the long-range antenna being arranged inside the front cover portion, the short-range antenna being arranged inside an upper vehicle-body cover portion of the vehicle body cover unit.

The efficacy that the present invention may achieve with the first primary technical measure is that the keyless controller is in electrical connection with the long-range antenna and the short-range antenna, such that when an electrical signal sensor that is operable to control the keyless controller is running short of electrical power to set the long-range antenna in a detection operation, the electrical signal sensor is positionable close to or on the short-range antenna to allow the electrical signal sensor to acquire a minor amount of electrical current through wireless transmission from the short-range antenna to thereby enable a detection operation for preset match between the electrical signal sensor and the keyless controller or not, and as such it is ensured that the motorcycle is ready to enter a traveling state at any time.

### BRIEF DESCRIPTION OF THE DRAWINGS

FIG. 1 is a schematic view showing a known keyless controller arrangement of a motorcycle.

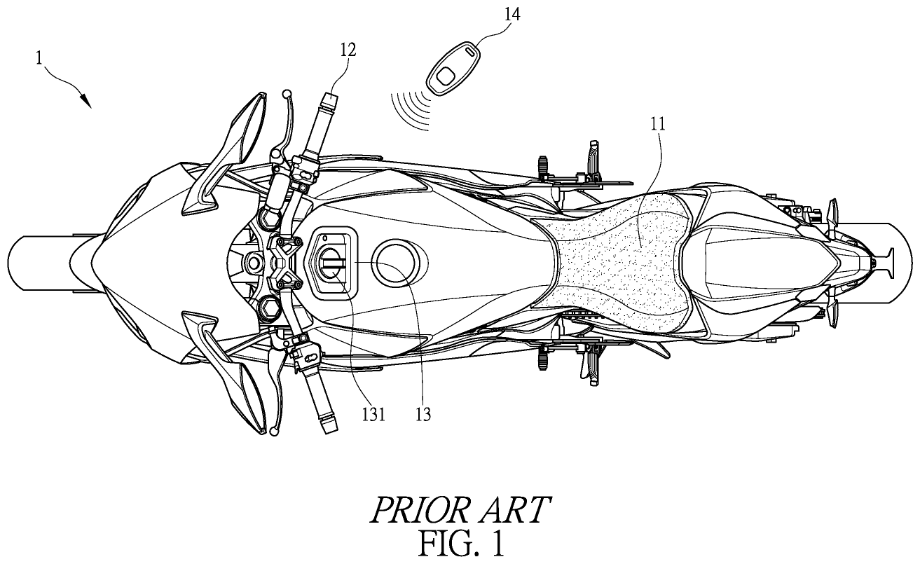

FIG. 2 is a schematic view showing a keyless controller arrangement of a motorcycle according to the present invention.

FIG. 3 is a perspective view showing the motorcycle according to the present invention, with a vehicle cover unit being removed.

FIG. 4 shows an example of the keyless controller and an arrangement of long-range and short-range antennas according to the present invention.

FIG. 5 is a top plan view showing the arrangement of the long-range and short-range antennas according to the present invention.

FIG. 6 is an exploded view showing the long-range antenna and a front cover according to the present invention.

FIG. 7 is an exploded view showing the short-range antenna and an upper vehicle-body top cover of an upper vehicle-body cover portion according to the present invention.

### DETAILED DESCRIPTION OF THE PREFERRED EMBODIMENT

For better understanding of the structure of the present invention, and the advantages achieved thereby, a description will be provided below with reference to the attached drawings.

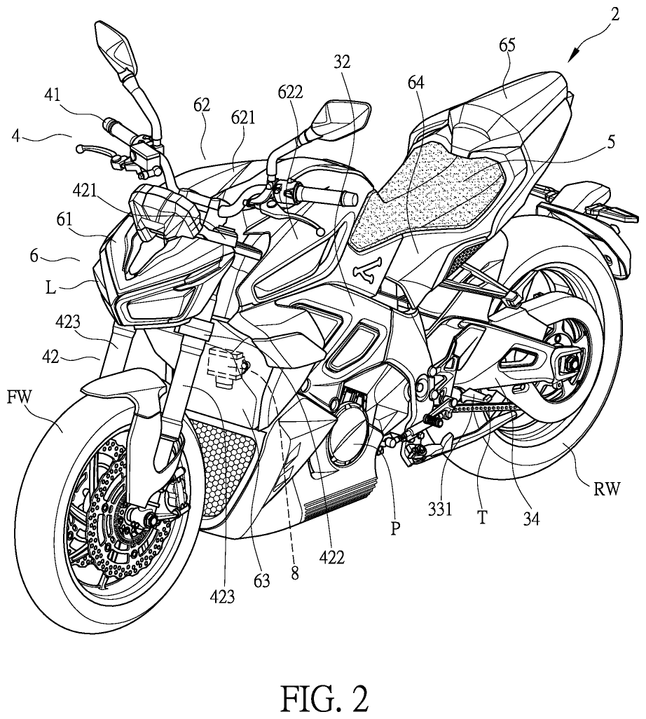

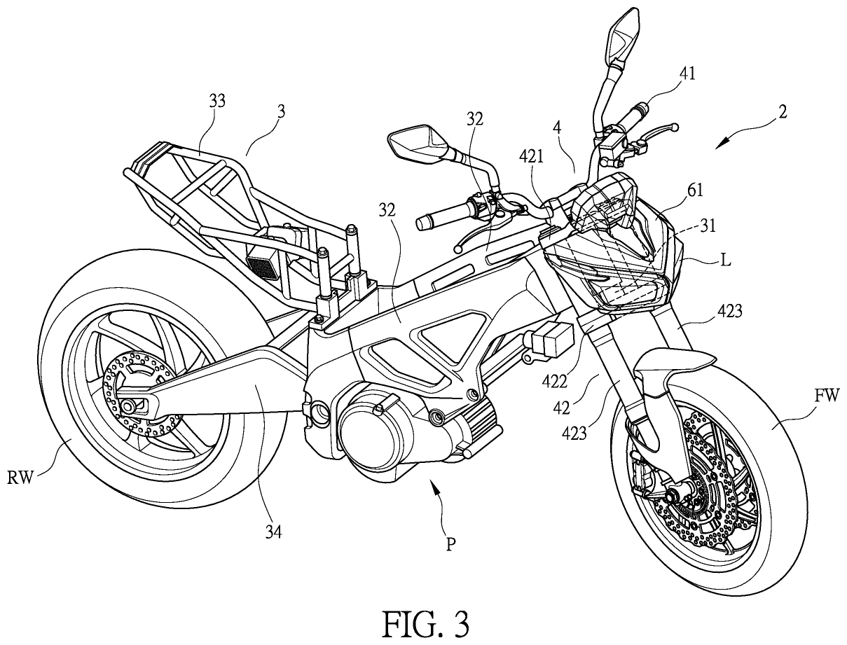

Firstly, referring to FIGS. 2 and 3, a motorcycle 2 according to the present invention at least comprises a vehicle frame unit 3. The vehicle frame unit 3 at least comprises a head tube portion 31 arranged toward a vehicle body front side, extension portions 32 arranged pairwise as a left one and a right one extending from the head tube portion 31 toward a vehicle body rear side and inclining downward, rear vehicle frame portions 33 arranged pairwise as a left one and a right one extending from the extension portions 32 toward a vehicle body rear top side, a rear swing arm assembly 34 rotatably mounted to a rear lower part of the extension portions 32, and a power unit P arranged at a rear end of the extension portions 32 and a front end of the rear vehicle frame portions 33. The power unit P of the motorcycle 2 is a motor. The power unit P drives, by means of a transmission member T, a rear wheel RW rotatably mounted to a rear end of the rear swing arm assembly 34. The vehicle frame unit 3 is covered, on a periphery thereof, by a vehicle body cover unit 6.

Referring to FIGS. 2 and 3, the head tube portion 31 of the vehicle frame unit 3 is provided for mounting a steering mechanism 4 that is provided for changing a traveling direction of the motorcycle 2. The steering mechanism 4 at least comprises a steering handle bar 41 extending in directions toward vehicle body left and right sides and a front fork assembly 42 arranged toward vehicle body top and bottom. The front fork assembly 42 comprises a top bridge portion 421, a bottom bridge portion 422, and front shock absorbers 423 that arranged pairwise as a left one and a right one. The top bridge portion 421 is located on an upper portion of the head tube portion 31, and the bottom bridge portion 422 is located on a lower portion of the head tube portion 31, meaning the head tube portion 31 is arranged between the top bridge portion 421 and the bottom bridge portion 422. The front shock absorbers 423 are arranged to extend from the top bridge portion 421 through the bottom bridge portion 422 toward the vehicle body lower side, and a front wheel FW of the motorcycle 2 is rotatably mounted to lower ends of the front shock absorbers 423. The steering handle bar 41 is connected to a top side of the top bridge portion 421.

As shown in FIGS. 2, 3, and 4, the rear vehicle frame portions 33 of the vehicle frame unit 3 are provided with a seat cushion 5 toward a vehicle body top side to receive a rider to sit thereon. The extension portions 32 of the vehicle frame unit 3 are provided with front foot pegs 331 toward the vehicle body rear side and on two lateral sides of the vehicle body for receiving feet to rest thereon. An energy storage device 7 is arranged between the seat cushion 5 and the steering mechanism 4 and located above the extension portions 32 of the vehicle frame unit 3 for supplying electrical power for operation of the power unit P. The vehicle body cover unit 6 comprises a front cover portion 61 that is set on and covers a front side of the top bridge portion 421 and the bottom bridge portion 422 of the front fork assembly 42, an upper vehicle-body cover portion 62 that is set on and covers a top side and two lateral sides of the energy storage device 7, a lower vehicle-body cover portion 63 that is set on and covers a rear side of the front fork assembly 42 and two lateral sides and a lower side of the extension portions 32, a later vehicle-body cover portion 64 that is set on and covers portions of the seat cushion 5 on the left and right lateral sides of the vehicle body, and a rear vehicle-body cover portion 65 that is set on and covers a top side of a rear-side vehicle body rearwardly of the seat cushion 5 and two lateral sides of the rear-side vehicle body. The front cover portion 61 is provided, in a direction toward a front side, with a headlight assembly L. The upper vehicle-body cover portion 62 comprises an upper vehicle-body top cover 621 located on a top end and an upper vehicle-body lateral cover 622 extending downward from and covering two lateral sides of the upper vehicle-body top cover 621, so that the upper vehicle-body cover portion 62 can completely receive therein and cover the energy storage device 7.

As shown in FIGS. 2, 4, and 5, the lower vehicle-body cover portion 63 of the vehicle body cover unit 6 is provided, in an interior thereof, with a keyless controller 8. The keyless controller 8 is in electrical connection with a long-range antenna 81 arranged inside the front cover portion 61 and is in electrical signal connection with a short-range antenna 82 arranged in the upper vehicle-body cover portion 62, and in electrical connection with and controlling a steering-mechanism electronic lock 83 arranged on the front fork assembly 42, and in electrical connection with a trigger button 84 arranged on the steering handle bar 41 of the steering mechanism 4.

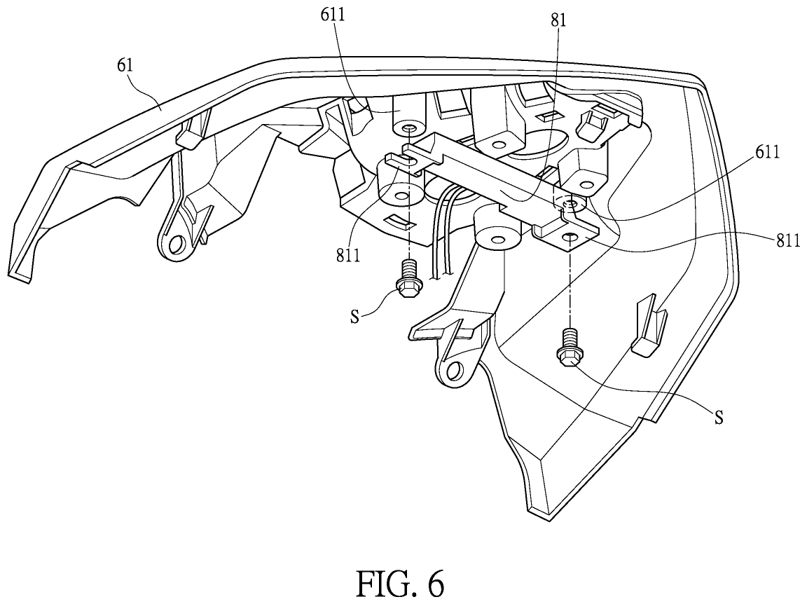

As shown in FIGS. 2, 4, 5, and 6, the front cover portion 61 is provided therein with a pair of fixing pillars 611. The fixing pillars 611 are formed with internal threads. The long-range antenna 81 is provided with a mounting portion 811 extending from two sides thereof, and one end of the mounting portion 811 is formed with a side-opening notch, so that fastening elements S may be applied to fasten into the mounting portion 811 of the long-range antenna 81 and the fixing pillars 611 of the front cover portion 61 to thereby fix the long-range antenna 81 inside the front cover portion 61.

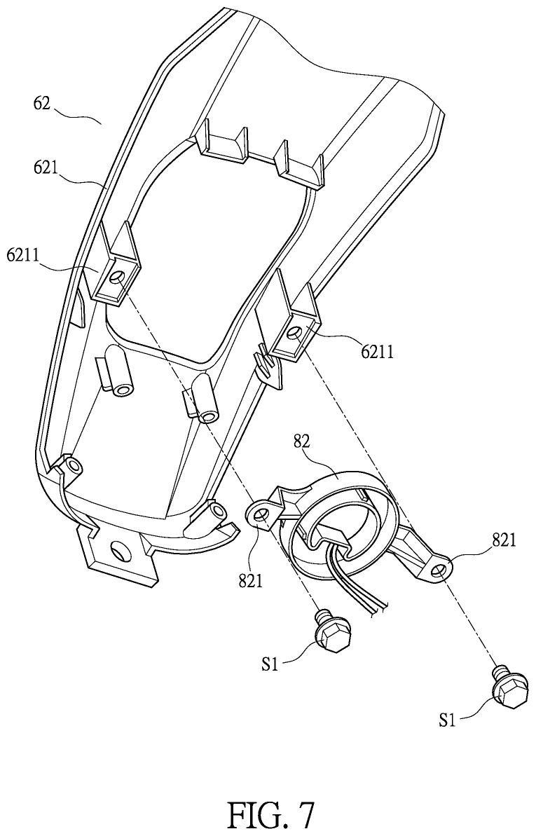

As shown in FIGS. 2, 4, 5, and 7, the upper vehicle-body top cover 621 of the upper vehicle-body cover portion 62 is formed, in an interior thereof, with a pair of mounting blocks 6211 as being projecting therefrom. The short-range antenna 82 is provided, on two sides thereof, with mounting lugs 821. Fastening elements 51 may be applied to fasten into the mounting lugs 821 of the short-range antenna 82 and the mounting blocks 6211 of the upper vehicle-body top cover 621, so as to fix the short-range antenna 82 inside the upper vehicle-body top cover 621 of the upper vehicle-body cover portion 62 to thereby set the energy storage device 7 between the short-range antenna 82 and the keyless controller 8.

As shown in FIGS. 3, 4, and 5, the steering-mechanism electronic lock 83 is mounted on a lower side of the top bridge portion 421 the front fork assembly 42 and is located between the front shock absorbers 423 that are arranged pairwise as a left one and a right one, so that the steering-mechanism electronic lock 83 is controllable by the keyless controller 8 for operation of locking up the steering mechanism 4 for being not free to rotate and releasing the locking for being free to rotate.

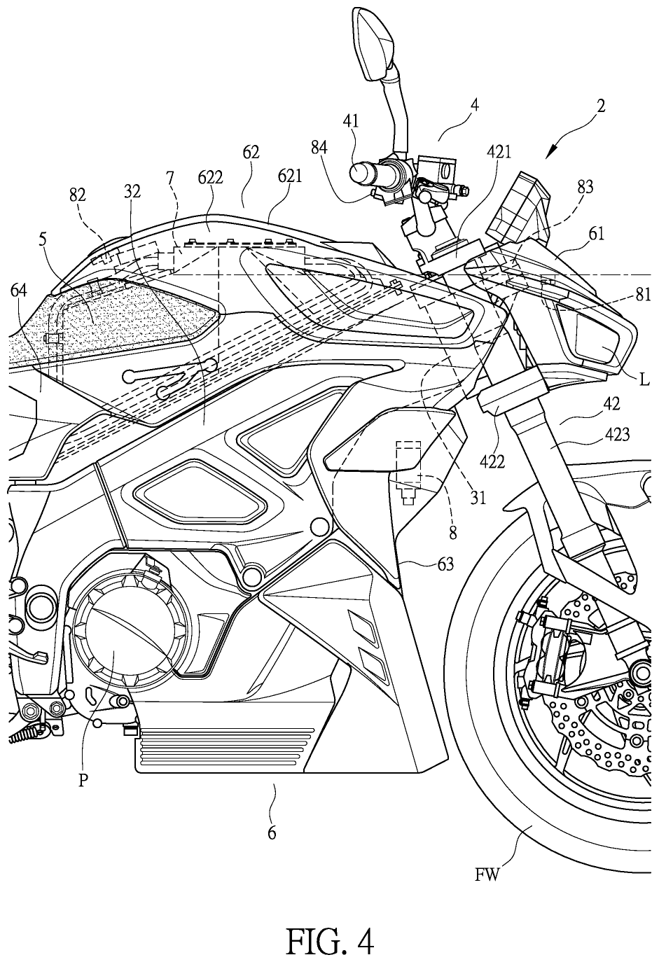

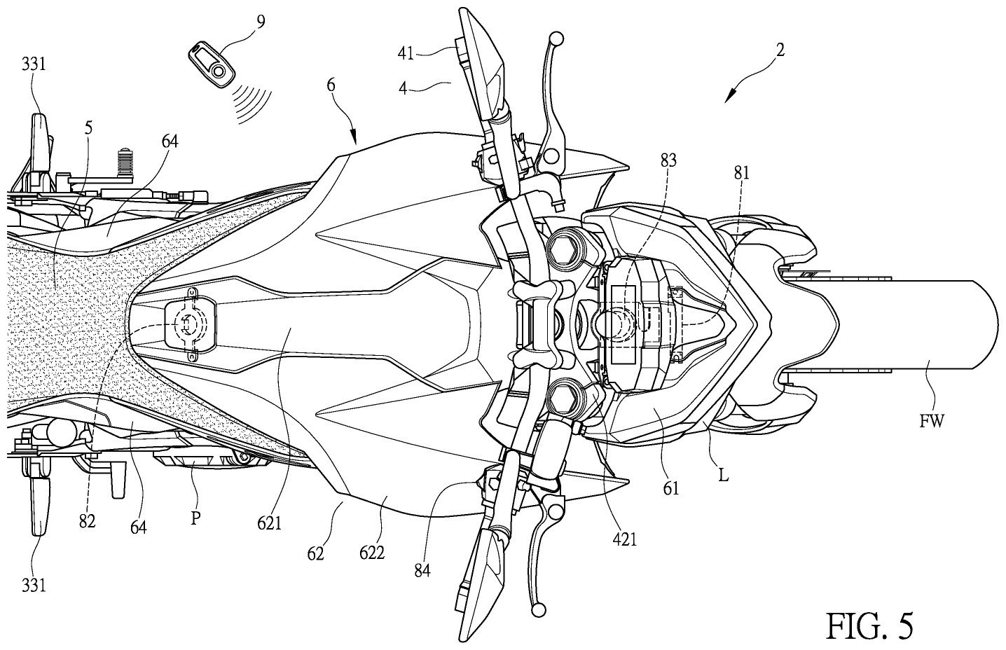

As shown in FIGS. 4 and 5, the trigger button 84 is mounted to one side of the steering handle bar 41 of the steering mechanism 4, so that the trigger button 84 of the keyless controller 8 is operable for being selective controlled to be conducting-on and conducting-off. When the trigger button 84 of the keyless controller 8 is controlled to be conducting-on, the rider may push down the trigger button 84 to start the power unit P, so as to make the motorcycle 2 enter a travelable state.

As shown in FIGS. 2, 4, and 5, the long-range antenna 81 is arranged in the interior of the front cover portion 61, wherein the long-range antenna 81 is set at a level height in a vehicle body top-bottom direction that generally corresponds to a level height of the energy storage device 7 in the vehicle body top-bottom direction, such that transmission of an electrical signal message from the long-range antenna 81 is prevented from being interfered with by the energy storage device 7. Further, the long-range antenna 81 is shielded, in the front side thereof, only by the front cover portion 61, so that there is no metal shielding interference caused by metal parts on the front side of the long-range antenna 81. As such, the effectiveness of transmitting and receiving an electrical signal message from and by the long-range antenna 81 can be enhanced. The short-range antenna 82 is arranged in the interior of the upper vehicle-body top cover 621 of the upper vehicle-body cover portion 62. When an electrical signal sensor 9 that is carried by the rider has a sufficient level of electrical power, within a predetermined long range, the keyless controller 8 uses the long-range antenna 81 to detect and identify if the electrical signal sensor 9 is one that is preset as a matched one, such that when the keyless controller 8 detects the electrical signal sensor 9 being matched therewith, the keyless controller 8 instructs the steering-mechanism electronic lock 83 to release locking of the steering handle bar 41 of the steering mechanism 4 to enable free rotatability of the steering handle bar 41 of the steering mechanism 4, and meanwhile, the keyless controller 8 also sets the trigger button 84 conducting, so that the rider may push down the trigger button 84 to start the power unit P, thereby allowing the motorcycle 2 to enter the travelable state. However, when the electrical signal sensor 9 is running short of electrical power to transmit a message, the rider may place the electrical signal sensor 9 to approach or adjacent to or be positioned on the short-range antenna 82, the short-range antenna 82 allows the electrical signal sensor 9 to acquire s minor amount of electrical current through wireless transmission, in order to carry out detection for preset match or not between the electrical signal sensor 9 and the keyless controller 8, thereby avoiding the deficiency that the motorcycle 2 cannot travel due to shortage of electrical power of the electrical signal sensor 9.

The primary efficacy of the present invention is that the motorcycle 2 comprises a vehicle frame unit 3, a vehicle body cover unit 6, and a steering mechanism 4 mounted on the vehicle frame unit 3, wherein the steering mechanism 4 comprises a steering handle bar 41 and a front fork assembly 42, and a front cover portion 61 of the vehicle body cover unit 6 is arranged on a front side of the front fork assembly 42, and a keyless controller 8 is arranged on a rear side of the front fork assembly 42; the keyless controller 8 is in electrical connection with a long-range antenna 81 and a short-range antenna 82, wherein the long-range antenna 81 is arranged inside the front cover portion 61 and the short-range antenna 82 is arranged inside an upper vehicle-body cover portion 62 of the vehicle body cover unit 6; the keyless controller 8 is in electrical signal connection with the long-range antenna 81 and the short-range antenna 82 such that when an electrical signal sensor 9 that is operable to control the keyless controller 8 is running short of electrical power to set the long-range antenna 81 in a detection operation, the electrical signal sensor 9 is positionable close to or on the short-range antenna 82 to allow the electrical signal sensor 9 to acquire a minor amount of electrical current through wireless transmission from the short-range antenna 82 to thereby enable a detection operation for preset match between the electrical signal sensor 9 and the keyless controller 8 or not, and as such it is ensured that the motorcycle 2 is ready to enter a traveling state at any time.

The second efficacy of the present invention is that an energy storage device 7 is arranged inside the upper vehicle-body cover portion 62 of the vehicle body cover unit 6 and below the short-range antenna 82, and the energy storage device 7 is located between the short-range antenna 82 and the keyless controller 8; and as such a space in a front vehicle half of the motorcycle 2 can be fully used.

The third efficacy of the present invention is that an energy storage device 7 is arranged inside the upper vehicle-body cover portion 62 of the vehicle body cover unit 6 and below the short-range antenna 82; a level height of the long-range antenna 81 and a level height of the energy storage device 7 are generally of the same height; and as such, electrical signals transmitted from the long-range antenna 81 and the short-range antenna 82 are prevented from being interfered with by the energy storage device 7.

The fourth efficacy of the present invention is that the motorcycle 2 further comprises an electrical signal sensor 9 that is operable to control activation of the keyless controller 8, and the keyless controller 8 in electrical connection with a steering-mechanism electronic lock 83 and in electrical connection with a trigger button 84; and as such, operation performance of the motorcycle 2 in respect of automatic control can be enhanced.

The fifth efficacy of the present invention is that the steering-mechanism electronic lock 83 is arranged below a top bridge portion 421 of the front fork assembly 42 and between front shock absorbers 423 of the front fork assembly 42 that arranged pairwise as a left one and a right one; and as such, a lower side of the top bridge portion 421 and the front shock absorbers 423 that are arranged pairwise as a left one and a right one help enhance stiffness protection for the steering-mechanism electronic lock 83.

The sixth efficacy of the present invention is that the trigger button 84 is mounted on the steering handle bar 41 of the steering mechanism 4; and as such, easiness of starting of the motorcycle 2 to enter the travelable state is achieved.

The seventh efficacy of the present invention is that a pair of fixing pillars 611 are arranged inside the front cover portion 61, and a mounting portion 811 is arranged on two sides of the long-range antenna 81, so that fastening elements S are applicable to fix the long-range antenna 81 to the fixing pillars 611 of the front cover portion 61; and as such, easiness of assembling and positioning of the long-range antenna 81 is achieved.

The eighth efficacy of the present invention is that one end of the mounting portion 811 is formed with a side-opening notch; and as such, easiness of assembling of the long-range antenna 81 is achieved.

The ninth efficacy of the present invention is that the upper vehicle-body cover portion 62 comprises an upper vehicle-body top cover 621 located on a top end and an upper vehicle-body lateral cover 622 extending downward from and covering two lateral sides of the upper vehicle-body top cover 621; the upper vehicle-body top cover 621 is formed, in an interior thereof, with a pair of mounting blocks 6211 as being projecting therefrom, and the short-range antenna 82 is provided, on two sides thereof, with mounting lugs 821, and fastening elements S1 are applicable to fix the short-range antenna 82 to the mounting blocks 6211 so as to fix the short-range antenna 82 in the interior of the upper vehicle-body top cover 621; and as such, easiness of assembling and positioning of the short-range antenna 82 is achieved.

The tenth efficacy of the present invention is that a lower vehicle-body cover portion 63 of the vehicle body cover unit 6 is arranged at a rea side of the front fork assembly 42, and the keyless controller 8 is arranged inside the lower vehicle-body cover portion 63 of the vehicle body cover unit 6; and as such, concealability of the keyless controller 8 is achieved, and a space inside the lower vehicle-body cover portion 63 of the vehicle body cover unit 6 is well used.

In summary, the above-described structure of the present invention could improve the shortcomings of the prior art and achieve the desired purpose, and shows apparent improvement in respect of performance over the prior art and thus completely complies with the requirements for novelty, utilization, and inventiveness, and an application for patent is thus filed for pursuing grating of patent.

I claim:

1. A motorcycle keyless controller arrangement structure, wherein a motorcycle comprises a vehicle frame unit, a vehicle body cover unit, and a steering mechanism mounted on the vehicle frame unit, the steering mechanism comprising a steering handle bar and a front fork assembly, a front cover portion of the vehicle body cover unit being arranged on a front side of the front fork assembly, a keyless controller being arranged on a rear side of the front fork assembly; the keyless controller is in electrical connection with a long-range antenna and a short-range antenna, the long-range antenna being arranged inside the front cover portion, the short-range antenna being arranged inside an upper vehicle-body cover portion of the vehicle body cover unit.

2. The motorcycle keyless controller arrangement structure according to claim 1, wherein an energy storage device is arranged inside the upper vehicle-body cover portion of the vehicle body cover unit and below the short-range antenna, and the energy storage device is located between the short-range antenna and the keyless controller.

3. The motorcycle keyless controller arrangement structure according to claim 1, wherein an energy storage device is arranged inside the upper vehicle-body cover portion of the vehicle body cover unit 6 and below the short-range antenna; a level height of the long-range antenna and a level height of the energy storage device are generally of the same height.

4. The motorcycle keyless controller arrangement structure according to claim 1, wherein the motorcycle further comprises an electrical signal sensor that is operable to control activation of the keyless controller, and the keyless controller is in electrical connection with a steering-mechanism electronic lock and in electrical connection with a trigger button.

5. The motorcycle keyless controller arrangement structure according to claim 4, wherein the steering-mechanism electronic lock is arranged below a top bridge portion of the front fork assembly and between front shock absorbers of the front fork assembly that arranged pairwise as a left one and a right one.

6. The motorcycle keyless controller arrangement structure according to claim 4, wherein the trigger button is mounted on the steering handle bar of the steering mechanism.

7. The motorcycle keyless controller arrangement structure according to claim 1, wherein a pair of fixing pillars are arranged inside the front cover portion, and a mounting portion is arranged on two sides of the long-range antenna, so that fastening elements are applicable to fix the long-range antenna to the fixing pillars of the front cover portion.

8. The motorcycle keyless controller arrangement structure according to claim 7, wherein one end of the mounting portion is formed with a side-opening notch.

9. The motorcycle keyless controller arrangement structure according to claim 1, wherein the upper vehicle-body cover portion comprises an upper vehicle-body top cover located on a top end and an upper vehicle-body lateral cover extending downward from and covering two lateral sides of the upper vehicle-body top cover; the upper vehicle-body top cover is formed, in an interior thereof, with a pair of mounting blocks as being projecting therefrom, and the short-range antenna is provided, on two sides thereof, with mounting lugs, and fastening elements are applicable to fix the short-range antenna to the mounting blocks so as to fix the short-range antenna in an interior of the upper vehicle-body top cover.

10. The motorcycle keyless controller arrangement structure according to claim 1, wherein a lower vehicle-body cover portion of the vehicle body cover unit is arranged at a rea side of the front fork assembly, and the keyless controller is arranged inside the lower vehicle-body cover portion of the vehicle body cover unit.
